(19) United States
(12) Patent Application Publication
(10) Pub. No.: US 2009/0159620 A1
(43) Pub. Date: Jun. 25, 2009

(54) DISPENSING DEVICE FOR DISPENSING A LIQUID PRODUCT

(75) Inventor: Keld Krogh Nielsen, Graasten (DK)

Correspondence Address: MCCORMICK, PAULDING & HUBER LLP, CITY PLACE II, 185 ASYLUM STREET, HARTFORD, CT, 06103, US

(73) Assignee: Logidos ApS, Aabenraa (DK)

(21) Appl. No.: 12/273,581

(22) Filed: Nov. 19, 2008

(30) Foreign Application Priority Data
Dec. 19, 2007 (DK) 2007 01828
Apr. 21, 2008 (DK) 2008 00571

(51) Int. Cl. B67D 3/00; G01F 11/26

(52) U.S. Cl. 222/478; 222/456; 222/547

(57) ABSTRACT

A dispensing device (1) for dispensing a liquid product from a container is disclosed. The dispensing device (1) comprises a first chamber (12) and a second chamber (13), an inlet passage (4) establishing a fluid connection between the first chamber (12) and an interior part of a container having the dispensing device (1) mounted thereon, and an outlet passage (8) adapted to deliver liquid product being dispensed by means of the dispensing device (1), via the second chamber (13). An intermediate wall (11) divides an interior part of the dispensing device (1) into the first chamber (12) and the second chamber (13), the intermediate wall (11) being curved or inclined in such a manner that an intermediate passage (14) between the first chamber (12) and the second chamber (13) is defined at the position of an edge (15) of the intermediate wall (11), and in such a manner that the edge (15) protrudes in a direction towards the first chamber (12). Thereby liquid product is prevented from leaving the first chamber (12) via the intermediate passage (14) when the dispensing device (1) is tipped, and a very precise dosing is obtained. Furthermore, ‘glugging’ is prevented.

### CROSS REFERENCE TO RELATED APPLICATION

Applicant hereby claims foreign priority benefits under U.S.C. §119 from Danish Patent Application No. 2007 01828 filed on Dec. 19, 2007, and Danish Patent Application No. 2008 00571 filed Apr. 21, 2008, the contents of which are incorporated by reference herein.

### FIELD OF THE INVENTION

The present invention relates to a dispensing device for dispensing a liquid product, such as cleaning materials, detergents, softeners, liquid toilet soap, shampoo, medicine, etc. More particularly, the present invention relates to a dispensing device which is capable of dispensing a precise, metered amount of liquid product. The dispensing device of the present invention may advantageously be attached to a container containing a liquid product to be dispensed.

### BACKGROUND OF THE INVENTION

Dispensing devices for liquid products, e.g. of the kind mentioned above, are known in many varieties in the art. For instance EP 0 969 269 discloses a dosing device for metered dosing of liquid product. The device comprises an interior part which is divided into a dosing chamber and a delivering portion by means of an insertion. The liquid follows a Z-shaped path through the device, and only the amount of liquid which can be contained in the dosing chamber will be dispensed from the device each time the device is turned in a pouring movement. The insertion dividing the interior part of the dosing device into the dosing chamber and the delivering portion defines a wall extending substantially along a longitudinal axis of the dosing device.

EP 0 082 439 discloses a similar dosing device comprising a vertical dividing wall dividing an interior part of the device into a dosing chamber and an outlet chamber. The dosing device disclosed in EP 0 082 439 functions in a similar manner to the dosing device disclosed in EP 0 969 269.

GB 2 145 061 discloses another similar dosing device comprising two compartments divided by a partition wall extending substantially along a longitudinal axis of the dosing device.

The dosing devices disclosed in EP 0 969 269, EP 0 082 439 and GB 2 145 061 all suffer from the drawback that when a liquid product is dispensed via the disclosed dispensing devices, there is a specific tipping angle, or range of angles, of the device, where a direct passage from the interior of the container containing the liquid product and the exterior of the container occurs, via the dispensing device. When the dispensing device is tipped to this angle, it is therefore possible for liquid product to pass directly through the dispensing device without being metered to a predefined dose. Accordingly, a larger dose than the predefined dose may be dispensed from the device, and the dispensing device is thereby unreliable in this situation. Furthermore, the dispensing device tends to ‘gurgle’ or ‘glug’ when being tipped to this specific angle, and this is also undesirable. Such ‘gurgling’ or ‘glugging’ may in addition cause or worsen the problem of liquid product passing directly through the dispensing device.

Other kinds of known dispensing devices incorporate gaskets, valves, or valve-like features, for ensuring a reliable function of the devices. Such dispensing devices are, however, generally more complicated and therefore more expensive to manufacture.

### SUMMARY OF THE INVENTION

It is thus an object of the invention to provide a simple dispensing device for dispensing a liquid product, in which it is possible to prevent dispensing of an incorrect dose.

It is a further object of the invention to provide a simple dispensing device for dispensing a liquid product, in which ‘gurgling’ or ‘glugging’ can be prevented.

According to the invention, the above and other objects are fulfilled by providing a dispensing device for dispensing a liquid product from a container containing said product, the dispensing device comprising:
a first chamber and a second chamber,
an inlet passage establishing a fluid connection between the first chamber and an interior part of a container having the dispensing device mounted thereon,
an outlet passage adapted to deliver liquid product being dispensed by means of the dispensing device, said outlet passage being fluidly connected to the second chamber,
a first end wall delimiting the second chamber towards an interior part of a container having the dispensing device mounted thereon,
a second end wall delimiting at least the first chamber, the second end wall being arranged substantially opposite the first end wall, and
an intermediate wall dividing an interior part of the dispensing device into the first chamber and the second chamber, the intermediate wall extending from the second end wall in a direction towards the first end wall in such a manner that an intermediate passage is defined at a position of an edge of the intermediate wall, said intermediate passage providing fluid communication between the first chamber and the second chamber,
   wherein the intermediate wall is positioned in such a manner that a curve arranged on a surface of the intermediate wall and extending from the second end wall towards the edge of the intermediate wall has a portion having a tangent pointing in a direction towards the first chamber.

The dispensing device according to the invention is adapted to dispense liquid products, such as cleaning materials, liquid detergents, softeners, liquid soap, shampoo, or any other suitable kind of liquid product which it is desirable to dispense from a container containing the product. The dispensing device according to the invention is further capable of dispensing a metered dose of liquid product. The dispensing device according to the invention furthermore has a simple design and is thus easy to manufacture. This will be explained further below.

The inlet passage establishes a fluid connection between the first chamber and an interior part of a container having the dispensing device mounted thereon. Thus, when the dispensing device is mounted on a container, liquid product is allowed to pass from the interior of the container into the first chamber, and thereby into the dispensing device, via the inlet passage. Accordingly, when liquid product is dispensed from the container by means of the dispensing device, liquid product from the container first enters the dispensing device by entering the first chamber.

The outlet passage is fluidly connected to the second chamber, and it is adapted to deliver liquid product being dispensed by means of the dispensing device. Accordingly, when liquid product is dispensed by means of the dispensing device, it leaves the dispensing device from the second chamber and via the outlet passage.

The first end wall delimits the second chamber towards an interior part of a container having the dispensing device mounted thereon. Thus, when the dispensing device is mounted on a container, the first end wall provides an interface between the interior of the container and the interior of the dispensing device, i.e. it separates volumes defined by the container and the dispensing device, respectively. Accordingly, the first end wall prevents liquid product from entering the dispensing device in an uncontrolled manner, and liquid product can thereby only enter the dispensing device via the inlet passage as described above. The first and second chambers will normally also be delimited by side walls. Such side walls may be defined by the dispensing device and/or by a container having the dispensing device mounted thereon.

The first end wall may be a substantially planar wall, e.g. arranged substantially perpendicularly to a longitudinal axis defined by the container, or, alternatively, arranged in an inclined manner relatively to such a longitudinal axis. As an alternative, the first end wall may have any other suitable shape, e.g. a curved shape, such as a convex or concave shape, a wavy or corrugated shape, or any other suitable shape. Alternatively or additionally, a surface of the first end wall may be provided with one or more recesses, waves, corrugations, embossed patterns, etc.

The second end wall delimits at least the first chamber, and it is arranged substantially opposite the first end wall. In the present context the term ‘substantially opposite’ should be interpreted to mean that surfaces of the first end wall and the second end wall are facing each other with a mutual distance there between. The first end wall and the second end wall may be arranged substantially in parallel, but they may, alternatively, be arranged in such a manner that an inclination between the end walls is defined. Since the first end wall delimits the dispensing device towards the container, the second end wall thereby delimits at least the first chamber in a direction away from the container, i.e. towards the surroundings.

The second end wall may further delimit the second chamber in this direction. However, the second chamber may alternatively be delimited by an additional end wall, e.g. arranged at a level which is shifted relatively to the level of the second end wall. As another alternative, the second chamber may simply not be delimited in this direction. In this case the outlet opening may simply have an area corresponding to the cross sectional area of the second chamber at a level corresponding to the level where the second end wall is arranged, or at any other level.

The intermediate wall divides an interior part of the dispensing device into the first chamber and the second chamber. Accordingly, one surface of the intermediate wall faces the first chamber and another surface of the intermediate wall faces the second chamber. The intermediate wall may be solid in the sense that no cavities, channels or the like are defined inside the intermediate wall. In this case the intermediate wall is preferable thin, e.g. having a sheet-like structure. As an alternative, the intermediate wall may contain one or more hollow parts, e.g. in the form of one or more cavities and/or one or more channels, e.g. for facilitating or controlling a flow of air from the surroundings into the container during dispensing.

The intermediate wall extends from the second end wall in a direction towards the first end wall. Thus, the intermediate wall is attached to, is integrated with or abuts the second end wall, preferably in a sufficiently sealed or tight manner to prevent liquid product and/or air from passing between the second end wall and the intermediate wall.

Opposite the attachment or abutment of the intermediate wall to the second end wall, the intermediate wall is provided with an edge, the edge defining a free end of the intermediate wall. The intermediate wall extends in such a manner that an intermediate passage is defined at the position of the edge, the intermediate passage providing fluid communication between the first chamber and the second chamber, i.e. the intermediate wall ‘stops’ at a distance from the first end wall and from the side wall. Thus, liquid product can pass from the first chamber to the second chamber via the intermediate passage. When liquid product is dispensed from a container via the dispensing device, the liquid product passes from the container to the first chamber via the inlet passage, further into the second chamber via the intermediate passage, and finally the liquid product is delivered from the dispensing device via the outlet passage. At the same time, air passes in the opposite direction from the surroundings into the second chamber via the outlet passage, further into the first chamber via the intermediate passage, and finally into the container via the inlet passage, thereby filling the volume previously occupied by the dispensed amount of liquid product. The air passes through the passages in a substantially ‘dosed’ manner similar to the manner in which the liquid passes through the passages.

The intermediate wall is positioned in such a manner that a curve arranged on a surface of the intermediate wall and extending from the second end wall towards the edge of the intermediate wall has a portion having a tangent pointing in a direction towards the first chamber. Thereby the first chamber defines a cavity or a bowl-shaped region. This has the consequence that when the dispensing device is oriented in such a manner that the first chamber is arranged above the second chamber, then part of the intermediate wall is arranged at a higher level than the cavity or bowl-shaped region. Thus, when the dispensing device is oriented in this manner, liquid product which is contained in the first chamber will be trapped there, since it would have to move in an upwards direction, i.e. against the force of gravity, in order to pass the edge of the intermediate wall and through the intermediate passage. This is an advantage because it is thereby ensured that it is not possible to tip the dispensing device to an angle where liquid product is allowed to pass directly through the dispensing device, i.e. from the inlet passage to the outlet passage. Accordingly, the dispensing device of the invention does not leak, and the problems described above relating to ‘gurgling’ or ‘glugging’ are also avoided. Furthermore, it is ensured that precise doses of liquid product are always dispensed from the dispensing device. This will be explained further below.

The cavity or bowl-shaped region may be formed by the entire intermediate wall or by a smaller part of the intermediate wall. In the latter case, the region may be arranged close to the second end wall, close to the edge or somewhere between the second end wall and the edge.

The dispensing device of the present invention may advantageously be operated in the following manner. The dispensing device is mounted at an opening of a container containing liquid product to be dispensed by means of the dispensing device. Alternatively, the dispensing device may form an integral part of the opening of the container. The opening is normally arranged at a part of the container which is directed upwards when the container serves storage purposes only, i.e. when liquid product is not being dispensed. Thus, in this situation the liquid product in the container is not in contact with the opening, and thereby with the dispensing device.

When it is desired to dispense a dose of liquid product from the container, the container is tipped, and the dispensing device is tipped along, in such a manner that the first chamber moves towards a position above the position of the second chamber. This tipping movement causes liquid product from the container to enter the first chamber via the inlet passage. When the container has been tipped approximately 90° the cavity or bowl-shaped region will be arranged below neighbouring parts of the intermediate wall, and liquid product which has entered the first chamber is now trapped in the first chamber as described above, i.e. no liquid product is allowed to enter the second chamber via the intermediate passage. The cavity or bowl-shaped region ensures that the trapped liquid is not allowed to flow towards the second chamber. Thereby it is efficiently ensured that the liquid product is not allowed to pass directly through the dispensing device, in particular when the container is tipped approximately 90°, which is the most critical angle in this regard. Obviously, the dispensing device will function even more reliably when the container is tipped more than 90°.

The container is now tipped back to an upright position. During this movement the liquid product which is trapped in the first chamber is allowed to pass through the intermediate passage into the second chamber. The dispensing device may be designed in such a manner that the volume of the trapped liquid product exceeds the volume of the second chamber below the edge of the intermediate wall. In this case excess liquid product is preferably returned to the interior part of the container via the inlet passage when the container is tipped back to the upright position. After completion of the movement, the amount of liquid product contained in the second chamber constitutes a dose of liquid product.

Subsequently the container, and thereby also the dispensing device, is once again tipped in such a manner that the first chamber moves towards a position above the position of the second chamber. Thereby the liquid product contained in the second chamber moves out of the dispensing device via the outlet passage. Simultaneously, a new amount of liquid product enters the first chamber via the inlet passage as described above, and the dispensing device is thereby ready to deliver a dose of liquid product the next time the container is tipped. Accordingly, each time the container is tipped as described above, a precise dose of liquid product is dispensed from the container, the size of the dose being determined by the amount of liquid flowing from the first chamber to the second chamber through the intermediate passage. Depending on the actual design of the dispensing device, this amount may be determined primarily by the volume of the first chamber and the position of the inlet passage or by the sub-volume of the second chamber defined by side walls of the dispensing device, the first end wall and the level of the edge of the intermediate wall, depending on which of these volumes is smaller. In other words, the size of the dispensed dose is defined by the amount of liquid product which is both allowed to be trapped in the first chamber when the container is tipped and subsequently allowed to be contained in the part of the second chamber below the edge of the intermediate wall when the container is in an upright position.

Since the intermediate wall is arranged in the manner described above, there is no time during the operation described above where liquid product is allowed to pass directly from an interior part of the container through the inlet passage, the first chamber, the intermediate passage, the second chamber and the outlet passage. Thereby it is ensured that the exact metered dose defined above is dispensed each time the container is tipped as described. Accordingly, the dispensing device of the invention is capable of dispensing doses of liquid product which are more accurate than doses dispensed from similar prior art dispensing devices.

Preferably, the dispensing device of the present invention and its connection to the container are air-tight so that air is not allowed to enter or leave the container or the chambers during the tipping operation, except through the same passages as the liquid. In this embodiment, an underpressure will form in the container when it is tipped. This underpressure will counteract the weight of the liquid in the container, and thus hinder the weight of the liquid in the container from causing a steady liquid flow through the dispensing device and out of the container.

The intermediate wall may be inclined relatively to a longitudinal direction defined by the dispensing device. In this case the intermediate wall may advantageously be a substantially planar wall. Alternatively, the intermediate wall may be curved along a direction which is substantially perpendicular to the direction in which the intermediate wall extends. In this case the intermediate wall may have the shape of a section of the wall of a cylinder, the main axis of the cylinder being arranged inclined relatively to the longitudinal direction. The longitudinal direction defined by the dispensing device may advantageously be a substantially vertical direction when a container having the dispensing device mounted thereon is in an upright position in which it is normally positioned during storage, i.e. when the container is standing on a bottom part.

Alternatively or additionally, the intermediate wall may be curved along a direction extending from the second end wall towards the first end wall. In this case the intermediate wall follows a curved path rather than simply being inclined relatively to a longitudinal direction of the dispensing device. The curvature of the intermediate wall may be concave as seen from the first chamber, i.e. the intermediate wall may ‘bend into’ the first chamber, thereby forming the cavity or bowl-shaped region.

According to a preferred embodiment, the dispensing device may comprise a first part and a second part, the first part and the second part being interconnected, thereby forming the dispensing device. According to this embodiment, the dispensing device is formed by two parts which are manufactured independently. The two parts are subsequently interconnected, permanently or detachably, to form the dispensing device. From a manufacturing point of view it is an advantage that the dispensing device comprises two separate parts, in particular because it is easier to form parts arranged inside the dispensing device, in particular the intermediate wall. For instance, this makes it possible to manufacture the dispensing device by means of injection moulding, and the manufacturing costs may thereby be considerably reduced. However, as an alternative the dispensing device may be manufactured in a single piece.

The first part may comprise guiding means and the second part may comprise the intermediate wall, the guiding means being adapted to guide the intermediate wall in such a manner that a desired position and/or shape of the intermediate wall is obtained. According to this embodiment, the intermediate wall may simply be a planar wall which is sufficiently resilient to allow the wall to change shape and/or position when being guided by the guiding means. It is easier to produce such a planar wall than it is to produce a wall having a desired and precise inclination or curvature. However, the desired inclination or curvature is obtained by means of the guiding means. Accordingly, the desired position and/or shape, e.g. curvature, of the intermediate wall is obtained in an easy manner, the manufacturing of the dispensing device is facilitated, and the manufacturing costs may thereby be reduced.

The guiding means may be adapted to cause the intermediate wall to curve, e.g. providing a concave curvature as described above. Alternatively, the guiding means may be adapted to provide an inclination of the intermediate wall.

The guiding means may comprise a pair of tracks adapted to receive side edges of the intermediate wall. In this case the tracks preferably define paths which the edges of the intermediate wall follow when the first part and the second part are interconnected to form the dispensing device. These paths are shaped and arranged in such a manner that a desired inclination and/or curvature is provided for the intermediate wall. As described above, the intermediate wall is preferably sufficiently resilient to allow it to adapt to the shape and position of the tracks. Furthermore, such tracks may provide a sealing function, thereby ensuring that liquid product and/or air are only allowed to pass between the first and second chambers via the intermediate passage.

The dispensing device may further comprise means for mounting the dispensing device on a container. In this case the dispensing device can be mounted onto a container containing liquid product to be dispensed. The dispensing device may be adapted to be detachably mounted on the container, in which case it may be adapted to be retrofitted onto the container. In this case the end user may be able to mount the dispensing device onto a desired container. The dispensing device may even be reusable in the sense that when the container is empty, the end user may remove the dispensing device and mount it on a new container. Alternatively, the manufacturer of the liquid product which is stored in the container may mount the dispensing device on the container, in which case the container may advantageously be sold with the dispensing device mounted thereon.

Alternatively, the mounting means may be of a kind which causes the dispensing means to be permanently mounted on the container, e.g. by means of a snap fit, glue or moulding. In this case the dispensing device is preferably mounted on the container by the manufacturer of the liquid product being stored in the container.

The mounting means may comprise a threaded portion. The threaded portion is preferably adapted to engage with a corresponding threaded portion formed at or near an outlet opening of the container. Thereby the dispensing device can be mounted on the container by means of a rotating movement. In this case the dispensing device is mounted on the container in a detachable manner. The threaded portion may be designed in such a manner that when the dispensing device is mounted on a particular container, the dispensing device will be arranged in a desired orientation, e.g. relatively to a handle of the container, when the thread has been tightened in a normal manner. Thereby a desired orientation of the dispensing device, as well as a sufficient sealing between the dispensing device and the container, is ensured.

The inlet passage may be arranged at a level between the edge of the intermediate wall and the second end wall. In this case the inlet passage may advantageously be formed in a side wall of the first chamber. Positioning the inlet passage at a level between the edge of the intermediate passage and the second end wall has the advantage that it is ensured that liquid product entering the first chamber via the inlet passage will be ‘trapped’ by the intermediate wall as described above. Furthermore, it should be noted that the closer to the second end wall the inlet passage is arranged, the easier it will be to allow the last part of the liquid product of the container to be dispensed by the dispensing device.

According to one embodiment, a sub-volume of the first chamber defined between the inlet passage and the second end wall may be substantially equal to a sub-volume of the second chamber defined between the first end wall and the edge of the intermediate wall. According to this embodiment the amount of liquid product trapped in the first chamber, i.e. the metered dose, is substantially equal to the amount which may be contained in the second chamber below the edge. Thereby the overall dimensions of the dispensing device can be minimised.

The outlet opening may be arranged in the second end wall. According to this embodiment the outlet opening is arranged in the top of the container, similarly to ordinary containers without a dispensing device. Thus, the operations to be performed by the user in order to dispense a dose are similar to the operations which the user needs to perform when using an ordinary container.

When used with a large container, i.e. a container with a volume of around 1.5 l or more, the increased weight of the liquid in the container may cause the dispensing device to ‘leak’, i.e. to deliver a continuous stream of liquid, when the container is tipped. To prevent this, the area of the inlet opening constituting the inlet passage may be reduced. The inlet opening may have an area of less than 10 mm², preferably less than 5 mm² and more preferably less than 2 mm². In these cases, a precise dosing of liquid is obtained, even when the dispensing device is used with large containers.

The inlet passage may comprise at least two inlet openings. This allows rather viscous liquids in the container to be dispensed in precise doses, even when the container is nearly empty and the dispensing device has relatively small inlet openings.

The present invention further relates to a container for containing a liquid product, the container having a dispensing device according to the invention mounted thereon.

### BRIEF DESCRIPTION OF THE DRAWINGS

The invention will now be described in further detail with reference to the accompanying drawings in which

FIG. 1 is a perspective view of a dispensing device according to an embodiment of the invention;

FIG. 2 is a side view of the dispensing device of FIG. 1;

FIG. 3 is a top view of the dispensing device of FIGS. 1 and 2;

FIG. 4 is a cross sectional view of the dispensing device of FIGS. 1-3, along the line A-A shown in FIG. 3;

FIG. 5 is a cross sectional view of a first part of the dispensing device of FIGS. 1-4; and

FIG. 6 is a cross sectional view of a second part of the dispensing device of FIGS. 1-4.

### DETAILED DESCRIPTION OF THE PREFERRED EMBODIMENTS

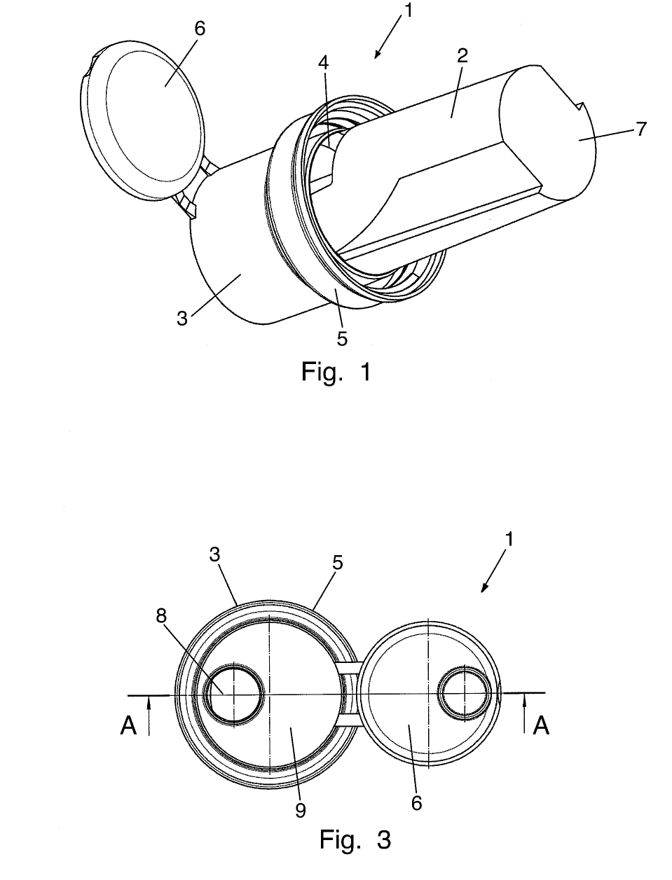

FIG. 1 is a perspective view of a dispensing device 1 according to an embodiment of the invention. The dispensing device 1 is formed by a first part 2 and a second part 3 being interconnected. The first part 2 has an inlet passage 4 through which liquid from a container having the dispensing device mounted thereon can pass into the dispensing device 1. The second part 3 is provided with a shoulder 5 and a lid 6 for opening/closing an outlet passage (not visible in FIG. 1) establishing a fluid connection between the interior and the exterior of the dispensing device 1. The shoulder 5 is provided with an inner thread adapted to match an outer thread arranged at an opening of a container. Thereby the dispensing device 1 can easily be mounted air-tight on an outlet opening of a container with the first part 2 protruding into the container and the shoulder 5 arranged on an exterior part of the outlet opening of the container. When the dispensing device 1 is mounted on a container in this manner, it is possible to pour metered doses of liquid from the container via the dispensing device 1. A first end wall 7 delimits the dispensing device 1 towards an interior part of the container.

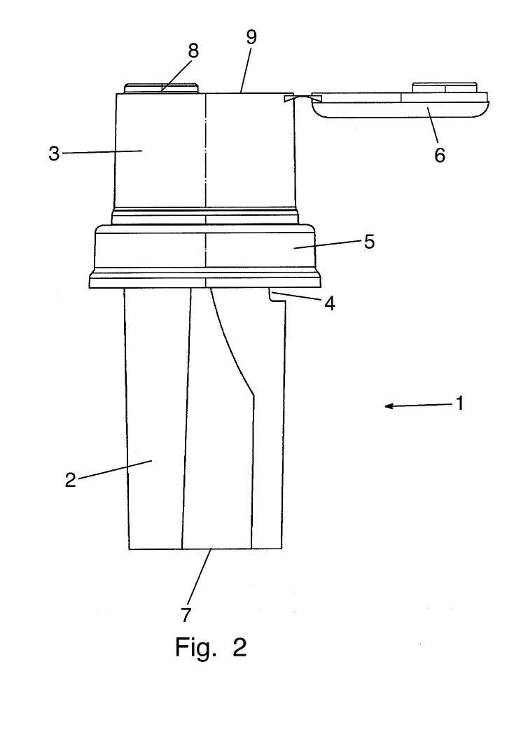

FIG. 2 is a side view of the dispensing device 1 of FIG. 1. In FIG. 2 the outlet passage 8 arranged in a second end wall 9 is visible.

FIG. 3 is a top view of the dispensing device 1 of FIGS. 1 and 2, i.e. as seen from the second end wall 9. The outlet passage 8 is clearly visible.

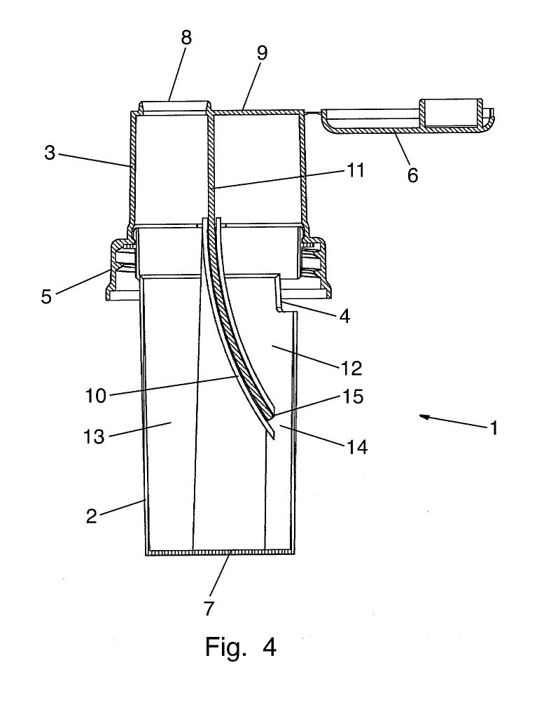

FIG. 4 is a cross sectional view of the dispensing device 1 of FIGS. 1-3 along the line A-A shown in FIG. 3. In FIG. 4 it can be seen that the first part 2 is provided with tracks 10 adapted to receive a flexible intermediate wall 11 forming part of the second part 3. Thus, when the first part 2 and the second part 3 are interconnected to form the dispensing device 1, the intermediate wall 11 is received in the tracks 10, and is thereby caused to follow the curvature defined by the tracks 10. Once the first part 2 and the second part 3 have been interconnected as shown in FIG. 4, the intermediate wall 11 extends from the second end wall 9 in a direction towards the first end wall 7, thereby dividing the interior of the dispensing device 1 into a first chamber 12 and a second chamber 13 with an intermediate passage 14 there between, allowing liquid product to pass between the first chamber 12 and the second chamber 13. Furthermore, an edge 15 of the intermediate wall 11 is arranged at a position which is shifted in a direction towards the first chamber 12 as compared to the position of the intermediate wall at the second end wall 9, i.e. to the right in FIG. 4. Accordingly, a curve arranged on a surface of the intermediate wall 11 and extending from the second end wall 9 towards the edge 15 of the intermediate wall 11 has a portion having a tangent pointing in a direction towards the first chamber 12. In the embodiment shown in FIG. 4 this portion will be constituted by the curve portion arranged on the curved portion of the intermediate wall 11.

When it is desired to dispense a dose of liquid product from a container having the dispensing device 1 mounted thereon, the container, and thereby the dispensing device 1, is tipped towards a position where the inlet passage 4 faces upwards. This corresponds to rotating the dispensing device 1 shown in FIG. 4 in an anticlockwise direction. This will cause liquid product to enter the first chamber 13 via the inlet passage 4. When the dispensing device 1 has been rotated approximately 90°, the edge 15 will be arranged at a higher level than any other part of the intermediate wall 11. Accordingly, the liquid product now contained in the first chamber 12 would have to flow in an upwards direction, against the force of gravity, in order to enter the second chamber 13 via the intermediate passage 14. As a consequence, this liquid product is trapped in the first chamber 12. The dispensing device 1 and its threaded connection to the container are air-tight, so that an underpressure is formed in the container when it is tipped. This underpressure ensures that the weight of the liquid remaining in the container does not exert a pressure on the trapped liquid, which would otherwise cause it to pass on towards the second chamber 13.

Next, the container and the dispensing device 1 are returned to the position shown in FIG. 4. Thereby liquid product, which was previously trapped in the first chamber 12, is allowed to enter the second chamber 13 via the intermediate passage 14. However, no additional liquid is allowed to enter the dispensing device 1 via the inlet passage 4, due to the underpressure formed in the container, and the amount of liquid product which is now contained in the second chamber 13 thereby constitutes an accurately metered dose of liquid product.

Next, the container and the dispensing device 1 are once again tipped as described above. Thereby the metered dose of liquid product contained in the second chamber 13 is poured via the outlet passage 8. Simultaneously, a new dose enters the first chamber 12 via the inlet passage 4, and the dispensing device 1 is immediately ready for delivering the next dose. The position of the edge 15 of the intermediate wall 11 prevents liquid product from flowing back to the first chamber 12 during the tipping operation.

A dispensing device 1 having the relative dimensions and the shapes shown in FIGS. 1-4 is particularly preferred, because it ensures that the amount of liquid trapped in the first chamber 12, i.e. the dispensed dose, is substantially independent of how a user performs the dispensing movements, e.g. to which angle the container is tipped, how fast it is tipped, etc. The reason for this is that the sub-volume of the first chamber 12 below a horizontal plane passing through the inlet passage 4 is substantially constant for all tipping angles between 90° and 180°. This is mainly a consequence of the curvature and relative position of the intermediate wall 11 and the relative position of the inlet passage 4.

In order for the dispensing device 1 according to the invention to function reliably, the interior of the container must be practically sealed off from the air surrounding the container when the container is in the tipped position after the metered dose has been poured out of the outlet opening 8. Otherwise, the weight of the liquid in the container would cause further amounts of liquid to be pressed out of the container through the dispensing device 1, which would eventually lead to an imprecise dosing or even to a complete emptying of the container. In this position, the liquid in the container gathers around and above the dispensing device 1, thereby covering the inlet passage 4. At the same time, the first chamber 12 contains liquid up to just above the inlet passage 4, and thereabove air. A person using the dispensing device 1 typically induces small variations of the tipping angle or vibrations to the container so that the liquid surface within the first chamber 12 may temporarily move below the upper edge of the inlet passage 4, thereby bringing the air within the first chamber 12 in direct contact with the liquid in the container at the inlet passage 4. In most practical cases, the surface tension of the liquid suffices to ensure that air from the first chamber 12 does not enter the interior of the container. With large containers, however, further measures may be required to ensure that the surface tension suffices to keep the liquid and air separated at the inlet passage 4.

Experiments conducted by the inventor have shown that large containers are more susceptible to ‘gurgling’ or ‘glugging’ than small containers. The exact reasons are unknown, but it is assumed that the relatively larger underpressure in the container, the larger inertia of the liquid, the relatively weaker container wall and the relatively larger effort required for a person to hold the container steady all contribute to this effect. The experiments have also shown that ‘gurgling’ or ‘glugging’ can be minimized or even completely prevented by reducing the size of the individual inlet openings, which constitute the inlet passage. In order to maintain an easy flow of liquid even when the container is nearly empty, the inlet passage 4 may comprise several inlet openings. An inlet passage 4 comprising several smaller inlet openings may for instance be provided by forming a mesh or grid structure in the wall of the dispensing device 1.

For liquids with viscosity and density close to those of water, the following areas of the individual inlet openings are preferably used: ca. 15 mm² for containers with a volume of up to 1 l; ca. 9 mm² for containers with a volume of 1.5 l; ca. 4 mm² for containers with a volume of 2.5 l; ca. 1 mm² for containers with a volume of 5 l.

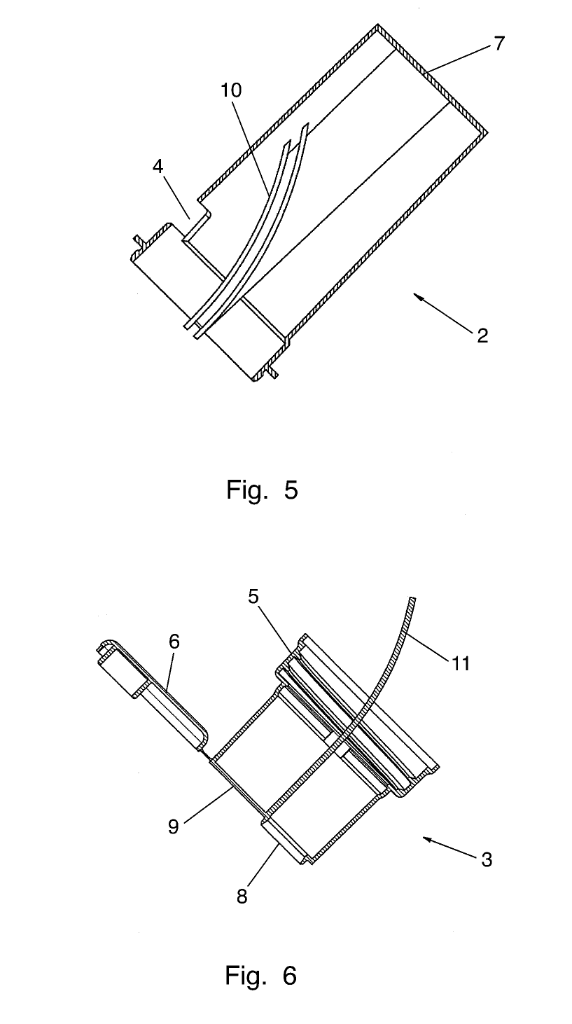

FIG. 5 is a cross sectional view of a first part 2 of the dispensing device 1 of FIGS. 1-4, and FIG. 6 is a cross sectional view of a second part 3 of the dispensing device 1 of FIGS. 1-4. The dispensing device 1 is formed by interconnecting the first part 2 shown in FIG. 5 and the second part 3 shown in FIG. 6. It is noted that the intermediate wall 11 shown in FIG. 6 has the shape which it will obtain when it is received in the tracks 10 shown in FIG. 5. It should, however, be understood that when the second part 3 is manufactured, the intermediate wall 11 is substantially planar and sufficiently flexible to be shaped by the tracks 10. This makes it very easy to manufacture the second part 3 by means of injection moulding.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A dispensing device for dispensing a liquid product from a container containing said product, the dispensing device comprising:
a first chamber and a second chamber,
an inlet passage comprising at least one inlet opening and establishing a fluid connection between the first chamber and an interior part of a container having the dispensing device mounted thereon,
an outlet passage adapted to deliver liquid product being dispensed by means of the dispensing device, said outlet passage being fluidly connected to the second chamber,
a first end wall delimiting the second chamber towards an interior part of a container having the dispensing device mounted thereon,
a second end wall delimiting at least the first chamber, the second end wall being arranged substantially opposite the first end wall, and
an intermediate wall dividing an interior part of the dispensing device into the first chamber and the second chamber, the intermediate wall extending from the second end wall in a direction towards the first end wall in such a manner that an intermediate passage is defined at a position of an edge of the intermediate wall, said intermediate passage providing fluid communication between the first chamber and the second chamber, wherein the intermediate wall is positioned in such a manner that a curve arranged on a surface of the intermediate wall and extending from the second end wall towards the edge of the intermediate wall has a portion having a tangent pointing in a direction towards the first chamber.

2. The dispensing device according to claim 1, wherein the intermediate wall is inclined relatively to a longitudinal direction defined by the dispensing device.

3. The dispensing device according to claim 1, wherein the intermediate wall is curved along a direction extending from the second end wall towards the first end wall.

4. The dispensing device according to claim 3, wherein the curvature of the intermediate wall is concave as seen from the first chamber.

5. The dispensing device according to claim 1, wherein the dispensing device comprises a first part and a second part, the first part and the second part being interconnected, thereby forming the dispensing device.

6. The dispensing device according to claim 5, wherein the first part comprises guiding means and the second part comprises the intermediate wall, the guiding means being adapted to guide the intermediate wall in such a manner that a desired position and/or shape of the intermediate wall is obtained.

7. The dispensing device according to claim 6, wherein the guiding means is adapted to cause the intermediate wall to curve.

8. The dispensing device according to claim 6, wherein the guiding means comprises a pair of tracks adapted to receive side edges of the intermediate wall.

9. The dispensing device according to claim 1, further comprising means for mounting the dispensing device on a container.

10. The dispensing device according to claim 9, wherein the mounting means comprises a threaded portion.

11. The dispensing device according to claim 1, wherein the inlet passage is arranged at a level between the edge of the intermediate wall and the second end wall.

12. The dispensing device according to claim 11, wherein a sub-volume of the first chamber defined between the inlet passage and the second end wall is substantially equal to a sub-volume of the second chamber defined between the first end wall and the edge of the intermediate wall.

13. The dispensing device according to claim 1, wherein the outlet passage is arranged in the second end wall.

14. The dispensing device according to claim 1, wherein the area of the largest inlet opening is less than 10 mm².

15. The dispensing device according to claim 1, wherein the area of the largest inlet opening is less than 5 mm².

16. The dispensing device according to claim 1, wherein the area of the largest inlet opening is less than 2 mm².

17. The dispensing device according to claim 1, wherein the inlet passage comprises at least two inlet openings.

18. A container for containing a liquid product, the container having a dispensing device according to 1 mounted thereon.
